(19) United States
(12) Patent Application Publication
(10) Pub. No.: US 2024/0149678 A1
(43) Pub. Date: May 9, 2024

(54) ROAD VEHICLE EQUIPPED WITH INTEGRATED CONTENT DISPLAY DEVICE

(71) Applicant: FERRARI S.P.A., Modena (IT)

(72) Inventors: Jonathan P. IVE, SAN FRANCISCO, CA (US); Eugene WHANG, SAN FRANCISCO, CA (US); Jeremy BATAILLOU, SAN FRANCISCO, CA (US); Anthony ASHCROFT, SAN FRANCISCO, CA (US); Suhang ZHOU, SAN FRANCISCO, CA (US); Benoit LOUZAOUEN, SAN FRANCISCO, CA (US); Jemima KISS, SAN FRANCISCO, CA (US); Christopher WILSON, SAN FRANCISCO, CA (US); Wan Si WAN, SAN FRANCISCO, CA (US); Biotz NATERA, SAN FRANCISCO, CA (US); James MCGRATH, SAN FRANCISCO, CA (US); Roger GUYETT, SAN FRANCISCO, CA (US); Joseph LUXTON, SAN FRANCISCO, CA (US); Michael MATAS, SAN FRANCISCO, CA (US); Patrick KESSLER, SAN FRANCISCO, CA (US); Patrizio MORUZZI, MODENA (IT); Vito CONIGLIARO, MODENA (IT)

(21) Appl. No.: 18/498,465

(22) Filed: Oct. 31, 2023

(30) Foreign Application Priority Data
Nov. 4, 2022 (IT) 102022000022695

(51) Int. Cl. B60K 35/21; B60K 35/65; G03B 21/56

(52) U.S. Cl. CPC B60K 35/21; B60K 35/654; B60K 35/656; G03B 21/56; B60K 2360/27; B60K 2360/66

(57) ABSTRACT

A road vehicle comprising: a vehicle dashboard, comprising in turn an exposed surface visible from the inside of the passenger compartment; a content display device comprising: a projection surface, which is arranged so as to substantially correspond to at least part of the exposed surface and configured to be visible to the passenger and/or to the driver while driving; at least one projection device, which is configured to project one or more contents onto the projection surface; wherein the projection surface follows at least a curvilinear line of the exposed surface.

### CROSS-REFERENCE TO RELATED APPLICATIONS

This patent application claims priority from Italian patent application no. 102022000022695 filed on Nov. 4, 2022, the entire disclosure of which is incorporated herein by reference.

### TECHNICAL FIELD

The present invention concerns a road vehicle provided with an integrated content display device.

In particular, the present invention is advantageously, but not exclusively, applied in a high-performance road vehicle, to which the following description will explicitly refer without loss of generality.

### BACKGROUND TO THE INVENTION

Generally, road vehicles are provided with a plurality of display devices arranged on the dashboard of the road vehicle.

Historically, each road vehicle comprises at least one display device for the driver, for example the screens or indicators arranged on the vehicle instrument panel, or on the portion of dashboard interposed between the steering wheel and the windscreen.

In recent years, said devices can be assisted by other screens (for example at least one screen arranged centrally on the dashboard or a head-up display) which complete display of the information for the driver.

In general, the arrangement of an increasingly large central screen is becoming increasingly popular, especially in fully electric cars; however, in the majority of cases, said central screens protrude from the dashboard to which they are connected, dominating it or creating an anti-aesthetic effect, nullifying part of the work of the interior designers who define the shape and curves of the dashboard.

In fact, for technical reasons, the screens in modern cars look like independent elements, not perfectly blended in with the style of the road vehicle in which they are installed.

In general, the need is therefore felt to increase the integration of the vehicle content display systems, giving the driver and the passenger a clear view of the display without having to sacrifice the aesthetics by imposing a rectangular screen in the centre of the dashboard.

### DESCRIPTION OF THE INVENTION

The object of the present invention is to provide a road vehicle equipped with an integrated content display device which is at least partially free from the above drawbacks and, at the same time, is easy and inexpensive to produce.

According to the present invention a road vehicle is provided equipped with an integrated content display device as claimed in the following independent claims and, preferably, in any one of the claims depending directly or indirectly on the independent claims.

The claims describe preferred embodiments of the present invention forming an integral part of the present description.

### BRIEF DESCRIPTION OF THE DRAWINGS

Below, some embodiments of the invention will be described for a better understanding thereof by way of non-limiting example and with reference to the attached drawings in which:

FIG. 1 is a perspective schematic view, with details removed for clarity, of a possible embodiment of a road vehicle in accordance with the present invention;

FIG. 2 is a perspective schematic view of part of the interior of the passenger compartment of the vehicle of FIG. 1 in which a central display device can be seen in a first embodiment;

FIG. 3 is a perspective schematic view of part of the interior of the passenger compartment of the vehicle of FIG. 1 in which a central display device can be seen in a second embodiment;

FIG. 4 is a perspective schematic view of part of the interior of the passenger compartment of the vehicle of FIG. 1 in which a central display device can be seen in a third embodiment;

FIG. 5 is a perspective schematic view of part of the interior of the passenger compartment of the vehicle of FIG. 1 in which a central display device can be seen in a fourth embodiment.

### EMBODIMENTS OF THE INVENTION

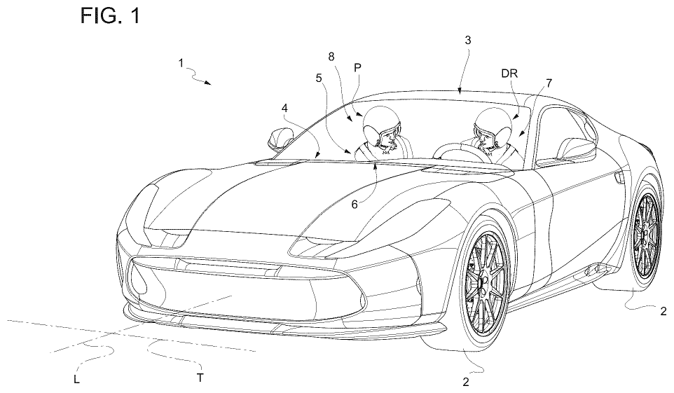

In FIG. 1, the number 1 indicates overall a road vehicle provided with two front wheels 2 and two rear wheels 2 (in particular driving wheels). The vehicle 1 is provided with a passenger compartment 3 which is adapted to house at least one driver DR and preferably one or more passengers P, of which at least one alongside the driver DR as illustrated in FIG. 1.

The same reference numbers and letters in the figures identify the same elements or components with the same function.

In the context of the present description the term “second” component does not imply the presence of a “first” component. Said terms are employed as labels to improve clarity and should not be understood in a limitative manner.

The elements and the characteristics illustrated in the different preferred embodiments, including the drawings, can be combined with or isolated from one another without departing from the protective scope of the present application as described below.

Furthermore, the road vehicle 1 comprises a frame (of known type and therefore not illustrated in detail), and a vehicle dashboard 4 inside the passenger compartment and fixed to the frame. The vehicle dashboard 4 is arranged frontally to the driver DR and to any passenger P and/or, at least partially, between the driver DR and any passenger P.

As illustrated in the non-limiting embodiments of the attached figures, the road vehicle 1 comprises a content display device 5, which is arranged at the vehicle dashboard 4, in particular on a central portion 6 of the vehicle dashboard 4 between a driving position 7 and a passenger position 8.

In particular, the dashboard 4 comprises in turn an exposed surface 9, which can be seen from the inside of the passenger compartment 3, namely from the driving position 7 or from the passenger position 8. More in particular, the exposed surface 9 is substantially the aesthetic finish surface of the dashboard 4, namely the curved surface that delimits the top of the dashboard 4.

Advantageously, the content display device comprises a projection surface 10, which is arranged so as to substantially correspond to at least part of the exposed surface 9 and is configured to be visible to the passenger P and/or to the driver DR while driving. In particular, the projection surface 10 is the surface which the driver DR or the passenger P looks at to view the content thereof.

In the non-limiting embodiments of the attached figures the projection surface 10 is arranged at the central portion 6 of the dashboard 4.

In detail, the content display device 5 further comprises at least one projection device 11, which is configured to project one or more contents IM (driving-related and/or distracting) onto the projection surface 10.

Advantageously, to make the display device 5 substantially integrated and therefore improve the aesthetics and curved design of the passenger compartment 3, the projection surface follows at least a curvilinear line of the exposed surface 9. In particular, the projection surface 10 corresponds to the exposed surface; therefore, preferably, the projection surface 10 is the exposed surface 9.

Advantageously but without limitation, the projection surface 10 is indistinguishable from the exposed surface 9 when the projection device 11 is switched off. In other words, if the projection device 11 is switched off, the projection surface 10 is not recognizable from the exposed surface 9, as it is perfectly integrated therein or is itself the projection surface 10, as will be described in further detail below. In this way, the dashboard 4 remains true to its shape, without being marred by a protruding rectangular screen.

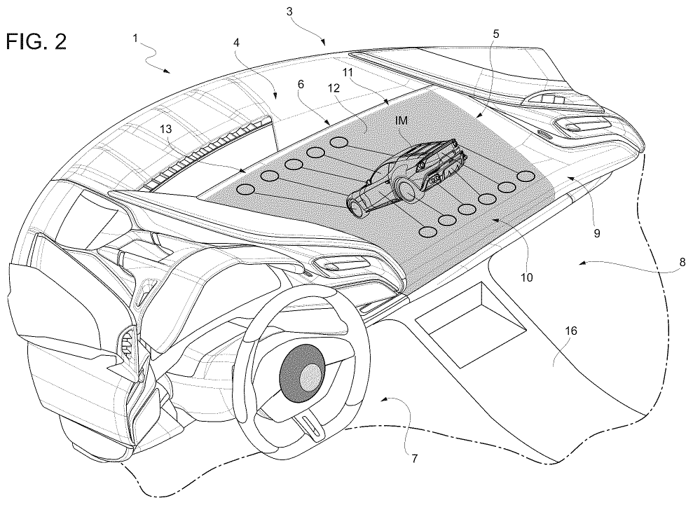

According to the non-limiting embodiment of FIG. 2, the projection device 11 is a curved screen 12, which is integrated in the dashboard 4 (namely it does not protrude from the exposed surface 9 and neither is it embedded therein, generating depressions) and substantially delimits at least part of the exposed surface 9. In particular, the projection surface 10 and the rest of the exposed surface are adjacent to each other and without interruption. In other words, the curved screen 12 is modelled so as to follow the surface curves of the exposed surface 9.

Advantageously but without limitation, the curved screen 12 is a screen of known type, for example a liquid crystal screen (LCD) or a LED (for example OLED) screen.

Preferably, the screen 12 is a touchscreen, thus also acting as an input interface for the driver DR or the passenger P.

In some preferred non-limiting cases, the content display device 5 comprises a transparent layer 13 (for example glass, preferably opaque) that covers the curved screen 12 and continues over the entire exposed surface 9. In this way, the exposed surface 9 looks like one single material, making the curved screen 12 even less visible when it is switched off. Substantially, with the vehicle switched off, the curved screen 12 is not distinguishable from the other shapes of the dashboard 4.

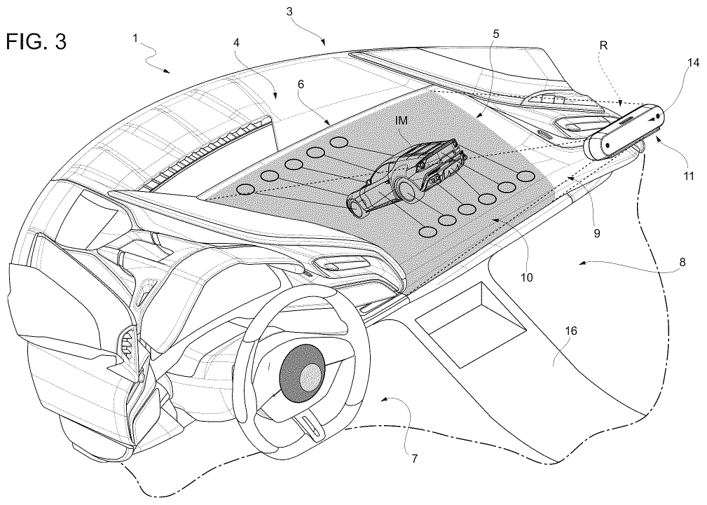

According to the non-limiting embodiment of FIG. 3, the projection device 11 is a video projector 14 arranged inside the passenger compartment 3, which projects the one or more contents IM onto the projection surface 10, which comprises at least part of the exposed surface 9. For example, without limitation, the projector 14 is installed at a ceiling fixture, namely the container for devices or sensors generally located centrally on the vehicle roof, at an upper side of the windscreen. In particular, therefore, the exposed surface 9 acts as a projection screen.

Advantageously but without limitation, the exposed surface 9 is made of an opaque material, preferably dark, in particular black (alternatively grey, or colour shades that comprise grey in their composition, for example dark brown, dark green, etc.). This maximizes the contrasts of the images generated by the video projector 14, improving the display thereof.

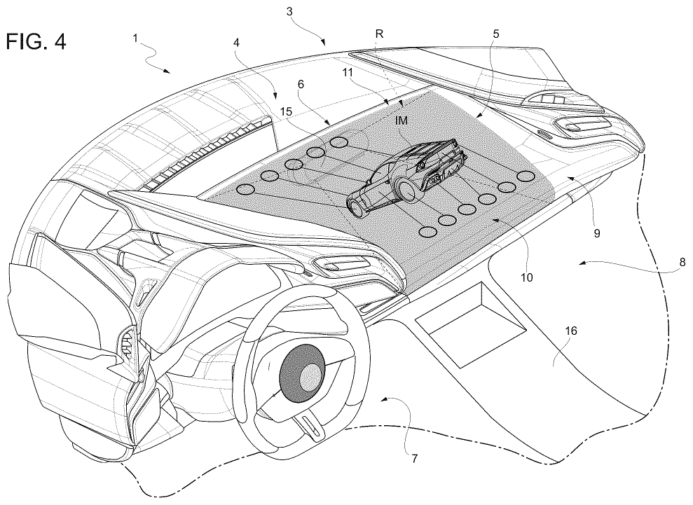

Alternatively, as illustrated in the non-limiting embodiment of FIG. 4, the projection device 11 is a video projector 15 arranged (entirely) within the dashboard 4, which back-projects the one or more contents IM onto the projection surface 10, which comprises at least part of the exposed surface 9. In particular, therefore, the exposed surface 9 acts as a back-projection screen. In this way, there is not even the risk of the driver DR or the passenger P influencing the image by moving or by arranging objects along the projection beams R (FIG. 3).

Advantageously but without limitation, the exposed surface 9 is made of a semi-transparent material in order to be crossed by the beams of the video projector 15 and produce the contents IM. Preferably, the semi-transparent material is dark, in particular grey or black. In this way, the quality of the back-projected image is improved.

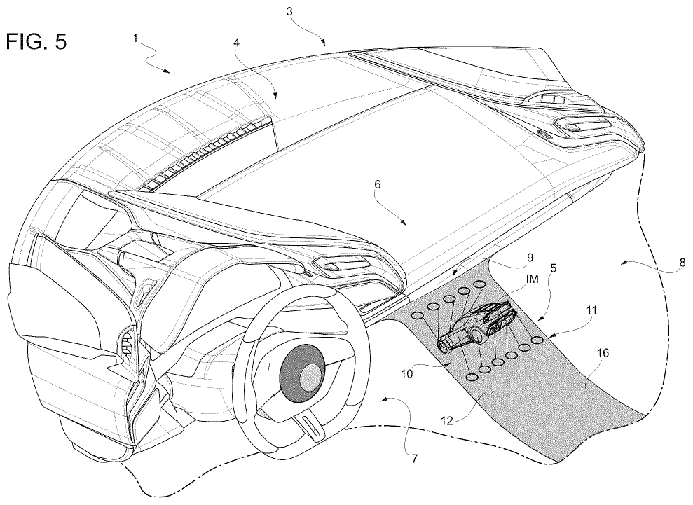

Each of the projection devices 11 described above can be used to produce the non-limiting embodiment of FIG. 5, in which the dashboard 4 comprises a central tunnel 16, arranged between the driving position 7 and the passenger position 8. In particular, the projection surface 10 is arranged at an upper portion 17 of the central tunnel 16. What has been said so far for the embodiments of FIGS. 2 to 4 also applies to the embodiment of FIG. 5.

In the non-limiting embodiments of FIGS. 2 to 4, the projection surface 10 extends mainly along an axis T transverse to a normal direction of travel of the road vehicle 1.

In the non-limiting embodiment of FIG. 5, the projection surface 10 extends mainly along an axis L transverse to a normal direction of travel of the road vehicle 1.

In use, while driving, the driver DR and the passenger P can easily view the projection surface 10. In particular, the projection device 11 projects and varies the contents IM according to the vehicle conditions (for example speed, accelerations applied, torque delivered, etc.).

Preferably, the display devices 5 described above are used also to provide suggestions to the driver DR for driving on racing circuits, for example of the type described in the Italian application 102021000025037 by the same Applicant.

Although the invention described above makes particular reference to a precise embodiment example, it should not be considered limited to said embodiment example, since its scope includes all the variations, modifications or simplifications covered by the attached claims such as, for example, a different type of road vehicle (for example with front wheel drive), a different shape of the passenger compartment, a different type of projection surface or device, an extreme curvature of the exposed surface, etc.

The vehicle described above has numerous advantages.

Firstly, it reduces the visual impact for the driver, eliminating protruding screens.

Furthermore, it improves flexibility in the design of road vehicle interiors, since the dashboard and the shapes thereof are no longer constrained by the presence of a large flat rectangular screen in the central portion.

### LIST OF REFERENCE NUMBERS OF THE FIGS.

1 vehicle
2 wheels
3 passenger compartment
4 dashboard
5 display device
6 dashboard central portion
7 driving position
8 passenger position
9 exposed surface
10 projection surface
11 projection device
12 curved screen
13 transparent layer
14 video projector
15 video projector
16 central tunnel
DR driver
IM contents
L longitudinal axis
P passenger
R projection beams
T transverse axis

1) A road vehicle (1) comprising:
four wheels (2), of which at least one pair of wheels (2) is a pairs of driving wheels;
a passenger compartment (3) configured to accommodate a driver (DR) and at least one passenger (P) alongside the driver (DR);
a vehicle dashboard (4), comprising in turn an exposed surface (9) visible from the inside of the passenger compartment (3);
a content display device (5);
the content display device (5) comprising:
a projection surface (10), which is arranged so as to correspond substantially to at least part of the exposed surface (9) and configured to be visible to the passenger (P) and/or to the driver (DR) while driving;
at least one projection device (11), which is configured to project onto the projection surface (10) one or more contents (IM);
wherein the projection surface (10) follows at least a curvilinear line of the exposed surface (9).

2) The road vehicle (1) according to claim 1, wherein the projection surface (10) is indistinguishable from the exposed surface (9) when the projection device (11) is switched off.

3) The road vehicle (1) according to claim 1, wherein the projection device (11) is a curved screen (12), integrated in the dashboard (4) and substantially delimiting at least part of the exposed surface (9).

4) The road vehicle (1) according to claim 3, wherein the content display device (5) comprises a transparent layer (13) that covers the curved screen (12) and continues for at least part of the remaining exposed surface (9).

5) The road vehicle (1) according to claim 1, wherein the projection device (11) comprises a video projector (14) arranged inside the passenger compartment (3), which projects the one or more contents (IM) onto the projection surface (10), which comprises at least part of the exposed surface (9).

6) The road vehicle (1) according to claim 5, wherein the exposed surface (9) is made of opaque material, preferably dark, in particular black.

7) The road vehicle (1) according to claim 1, wherein the projection device (11) comprises a video projector (15) arranged inside the dashboard (4), which back-projects the one or more contents (IM) onto the projection surface (10), which comprises at least part of the exposed surface (9).

8) The road vehicle (1) according to claim 7, wherein the exposed surface (9) is made of semi-transparent material, preferably dark, in particular grey or black.

9) The road vehicle (1) according to claim 1, wherein the dashboard (4) comprises a central tunnel (16), arranged between the passenger (P) and the driver (DR); wherein the projection surface (10) is arranged at an upper portion (17) of the central tunnel (16).
